(19) United States
(12) Patent Application Publication
(10) Pub. No.: US 2005/0120383 A1
(43) Pub. Date: Jun. 2, 2005

(54) System for saving settings of an audiovisual system

(76) Inventors: Arthur H. Ozaki, Escondido, CA (US); Peter Shintani, San Diego, CA (US)

Correspondence Address: STEVEN L. NICHOLS;RADER, FISHMAN & GRAVER PLLC, 10653 S. RIVER FRONT PARKWAY, SUITE 150, SOUTH JORDAN, UT, 84095, US

(21) Appl. No.: 10/727,134

(22) Filed: Dec. 2, 2003

(51) Int. Cl. H04N 7/173; G06F 17/00; G06F 9/00; G06F 3/00; H04N 7/16; H04N 7/18

(52) U.S. Cl. 725/131; 725/135; 725/100; 715/747; 348/734

(57) ABSTRACT

A system for saving settings of an audiovisual system includes a first audiovisual device with a setting and a second audiovisual device communicatively coupled to the first audiovisual device, wherein the second audiovisual device is configured to save the setting of the first audiovisual device upon a save event.

### BACKGROUND

In typical audiovisual systems such as home entertainment systems, a number of audiovisual (AV) devices are connected to an audiovisual presentation device such as a television or a projector. In conventional systems, the interaction of AV devices is limited because the AV devices are not able to communicate device-specific information or statuses to each other. Consequently, each device must be individually controlled. An operator of such an audiovisual system must individually operate and configure the AV devices of the system.

Seeking to improve the convenience of setup and operation, some systems have sought to combine controls for the AV devices into one device. However, these systems are cumbersome and complicated to configure and to operate. The control unit often must be used to manually reconfigure the system whenever a setting is changed or a device is added. For example, universal remote control devices have been incorporated into some audiovisual systems so that each audiovisual device can be controlled by a single remote control device. However, the universal remote control device must be specially programmed to communicate with each audiovisual device in an audiovisual system. For example, if a new AV device is added to the audiovisual system, the universal remote must be manually reconfigured in order to send effective signals to the new AV device. Accordingly, the operator typically must configure a macro run by the universal remote control device to include commands specific to the new AV device. Only then can the universal remote control device send the specific command signals necessary for controlling the new AV device. In short, typical audiovisual systems are inconvenient to configure and to operate.

### SUMMARY

A system for saving settings of an audiovisual system includes a first audiovisual device with a setting and a second audiovisual device communicatively coupled to the first audiovisual device, wherein the second audiovisual device is configured to save the setting of the first audiovisual device upon a save event.

### BRIEF DESCRIPTION OF THE DRAWINGS

The accompanying drawings illustrate various embodiments of the present invention and are a part of the specification. The illustrated embodiments are merely examples of the present invention and do not limit the scope of the invention.

FIG. 1 illustrates one embodiment of an audiovisual system according to the technology described herein.

FIG. 2 illustrates another embodiment of an audiovisual system according to the technology described herein.

FIG. 3 illustrates elements of the devices associated with the system in FIG. 1.

FIG. 4 is a flowchart illustrating one method for operating the system of FIG. 1.

Throughout the drawings, identical reference numbers designate similar, but not necessarily identical, elements.

### DETAILED DESCRIPTION

The present systems and methods described herein provide an audiovisual host device capable of saving and restoring settings associated with linked audiovisual components of an audiovisual system. Upon the occurrence of a specified event, the audiovisual host device can recognize the event and save the settings of the linked components. Then the audiovisual host device can cause the saved settings to be restored to the linked components upon the occurrence of a second specified event. A user of the audiovisual system is able to use the present systems and methods to conveniently configure and implement different combinations of system settings.

In some audiovisual or entertainment systems, a presentation device, which is frequently a television set, is setup to receive audiovisual programming signals from a variety of sources, including audiovisual component devices and head-end sources. The presentation device can then be used to present the audiovisual programming for a viewer.

In other audiovisual systems, a receiver unit, such as a set-top box, is setup to receive audiovisual programming signals from a variety sources, including audiovisual component devices and head-end sources. The receiver unit can then transmit the audiovisual programming signals to the presentation device, and the presentation device can be used to present the audiovisual programming for a viewer.

As used herein and in the appended claims, the term “audiovisual programming” will refer to any programming that can be displayed and viewed on a television set or other presentation device, including motion or still pictures with or without an accompanying audio soundtrack. “Audiovisual programming” will also be defined to include audio programming with no accompanying video that can be presented for a listener using a sound system of the television set, presentation device, or entertainment system. Audiovisual programming can be in any of several forms including, data recorded on a recording medium, an electronic signal being transmitted to or between system components, an electronic signal being transmitted to the audiovisual system from a source device, or content being presented on a television set or other presentation device.

Some or all of the components of an audiovisual system may be linked together by some type of connection medium. The connection medium and the components may be compliant with certain protocols or standards in order to enhance the interaction between the components. The Institute of Electrical and Electronics Engineers (IEEE) Standard 1394 (IEEE 1394), for a High Performance Serial Bus, is an electronics standard that describes a serial bus or pathway for transmitting digital data between connected devices. Any digital data can be transmitted including, for example, computer data and audio or audiovisual programming. Consequently, an IEEE 1394 pathway is often used to connect components of an audiovisual or entertainment system.

IEEE 1394 provides a single plug-and-socket connection on which up to 63 devices can be attached with data transfer speeds up to 400 Mbps (megabits per second). Many audiovisual and entertainment system components now come equipped to use an IEEE 1394 pathway. Such IEEE 1394 equipped devices may include an interface or port for connection to one or more other devices via an IEEE 1394 medium. IEEE 1394 offers the ability to chain devices together in a number of different ways without complicated set-up requirements. Two popular implementations of IEEE 1394 are the i.LINK® made by Sony Corp. of Tokyo, Japan and the FireWire® made by Apple Computer, Inc. of California.

With an IEEE 1394 connection in place, it is easy to transfer audiovisual programming among the various components of the audiovisual system for use by the components. Other digital signals, including instructions, data, or control commands can be transferred between components via the IEEE 1394 pathway. In some instances, one device may be able to request status signals from another device or send control signals to control the operation of another device. For example, the television set may be able to control the operation or settings of another audiovisual device.

Future products, such as home audiovisual servers, and other digital products of the future are expected to use the IEEE 1394 interface. Because an IEEE 1394 interface is a peer-to-peer interface, one device can send data directly to another. For example, a camcorder can use an IEEE 1394 interface to send video data directly to a computer or digital video recorder for dubbing, or to a digital television set for display.

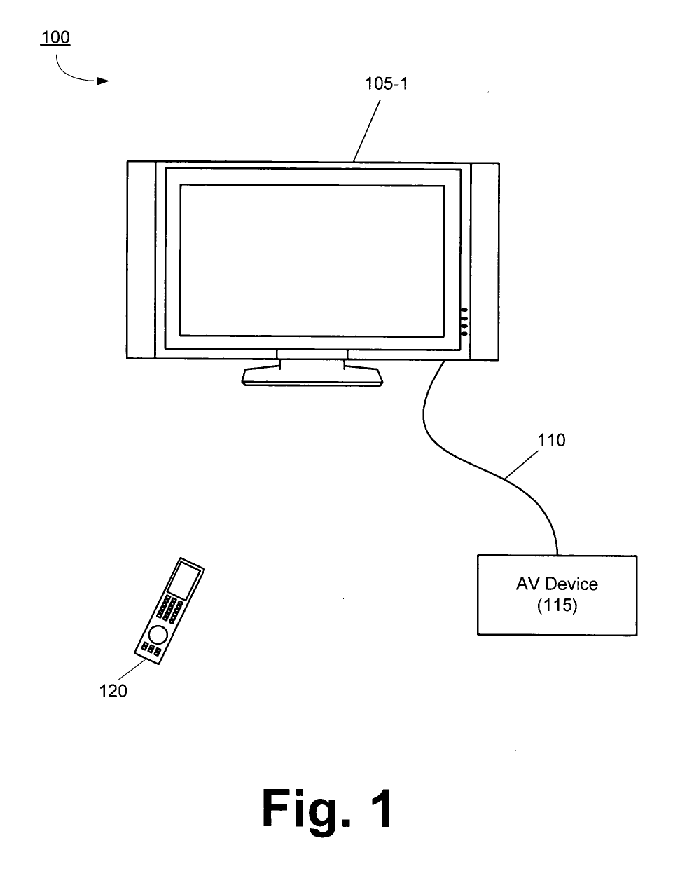

Referring now to the drawings, FIG. 1 illustrates an audiovisual system (100) (also referred to as “the system”) according to one embodiment of the technology described herein. In FIG. 1, a host device (105-1) is communicatively coupled by a connection medium (110) to an audiovisual (AV) device (115). A remote control device (120) can be used to interface with and control the host device (105-1) and/or the AV device (115). While FIG. 1 shows one host device (105-1), one connection medium (110), one AV device (115), and one remote control device (120) for illustrative purposes, it will be clear to one skilled in the art that different combinations of various numbers of the devices can be implemented to practice the system (100). The elements shown in FIG. 1 will now be discussed in more detail.

FIG. 1 shows the host device (105-1) coupled to the AV device (115) by the connection medium (110). The host device (105-1) may be or include any device capable of controlling one or more AV devices (115) that are connected by the connection medium (110). The host device (105-1) can be configured to communicate control signals to the AV device (115). The host device (105-1) may include but is not limited to a presentation device, a television set, a digital television set, a computer, and the like.

In regards to the ability of the host device (105-1) to control the AV device (115), the host device (105-1) can be configured to perform any function related to controlling linked AV devices (115). Such functions can include but are in no way limited to polling the AV devices (115) for information, receiving or obtaining information from the AV devices (115), saving and recalling the obtained information, causing a number of the AV devices (115) to power “on” or “off,” configuring or restoring the settings of the AV devices (115), waiting for specific signals from the AV devices (115) or from an operator of the system (100), receiving and executing operator input, and otherwise controlling the operation and settings of the AV devices (115). The host device (105-1) may include any hardware, firmware, middleware, software, memory, processor, communication port, circuitry, and peripheral device helpful to hosting or controlling one or more of the interconnected AV devices (115).

Along with the capability to control AV devices (115), the host device (105-1) may include audiovisual functionality for receiving, processing, recording, or presenting audiovisual programming. Such a host device (105-1) may be referred to as an audiovisual host device (105-1). The audiovisual host device (105-1) is able to receive audiovisual programming signals from a source, such as a head-end transmitter. The host device (105-1) can be configured to present the received audiovisual programming signals to the user of the system (100). Similarly, the host device (105-1) may be configured to transmit the received audiovisual programming signals to an AV device (115). For example, the host device (105-1) can be a television set configured to receive and present audiovisual programming signals as well as to control another linked AV device (115). In some embodiments, the audiovisual host device (105-1) is an audiovisual programming receiver such as a set-top box.

The host device (105-1) can be part of a network of AV devices (115), which network may include any number of AV devices (115). In some embodiments, the network of audiovisual devices includes a first AV device (115) and a second audiovisual device, in which the second audiovisual device includes the host device (105-1). The network of AV devices (115) can be linked by the connection medium (110).

The connection medium (110) can be any medium capable of communicatively coupling the host device (105-1) with the AV device (115). The connection medium (110) may include but is not limited to the IEEE 1394 medium discussed above, a high definition multimedia interface (HDMI) with Consumer Electronics Control (CEC), an audiovisual bus (AV-Bus), an internet protocol (IP) addressed network, a 10 Base-T network, a fiber medium, a wireless medium, an Ethernet network, a Home Plug interface, an infra red (IR) medium, and the like.

The connection medium (110) can carry electronic communications between the connected devices of the system (100). Through the connection medium (110), the host device (105-1) can learn the status of the AV device (115) or control the configuration or operation of the AV device (115). An electronic signal representative of a setting associated with the AV device (115) can be transmitted to the host device (115) via the connection medium (110). The host device (105-1) is able to transmit control signals to the AV device (115) via the connection medium (110). Accordingly, signals such as instructions or data needed to change or restore the settings of the AV device (115) can be communicated between the host device (105-1) and the AV device (115).

In some embodiments, the connection medium (110) is compliant with the IEEE 1394 standard. As discussed above, many or all of the components of an entertainment system (100) may include an IEEE 1394 interface for connection to one or more of the other system (100) components. Devices that are linked by the connection medium (110) can be equipped with the necessary hardware, software, and connections helpful for communicating over the connection medium (110). By equipping the host device (105-1) and the AV device (115) with IEEE 1394 interfaces and linking them with an IEEE 1394 pathway, it is easy to communicate digital signals between them.

As shown in FIG. 1, the AV device (115) is linked to the host device (105-1) via the connection medium (110). Similarly, multiple AV devices (115) can be communicatively linked over the connection medium (110). The AV device (115) can include but is not limited to a camera, a digital video disk (DVD) player or recorder, a digital video tape player, a camcorder, a digital video recorder (DVR), a set-top box, a television set, a music system, a video cassette recorder (VCR), an audiovisual programming receiver, a computer, a personal digital assistant (PDA), an audiovisual processor, a video gaming device, a compact disc player or recorder, a personal video recorders (PVR), a projector, a presentation device, and the like. The AV device (115) can be digital or analog.

The AV device (115) may be equipped with an interface for communicating with the host device (105-1) or with another linked AV device (115) via the connection medium (110). In some embodiments, the interface is an IEEE 1394 interface or port. The IEEE 1394 interface and pathway make it easy for the AV device (115) to send and receive digital signals from other linked devices. The AV device (115) may include any hardware, firmware, middleware, software, memory, processor, port, circuitry, interface, and peripheral device helpful to communicating with the host device (105-1) via the connection medium (110).

The AV device (115) may include one or more settings, which settings are also referred to as device settings. The settings can include any data tending to describe the status of operation or configuration of the AV device (115). A setting may include but is not limited to a power status of the AV device (115), a selected channel of audiovisual programming, a volume setting, a status of current operations, a selected input or output channel, an interface or network configuration, a presentation setting, a visual setting, an audio setting, a personalized setting, and the like. By way of example, the settings may include personalized settings for the sharpness, color, and brightness of the picture. Audio settings such as treble and bass levels are also settings that can be personalized. The term “system settings” refers to a combination of device settings and/or configuration settings related to the system (100).

Through the connection medium (110), the AV device (115) can make the settings available to another component of the system, including the host device (105-1). The AV device (115) may be configured to transmit the setting to the host device (105-1) upon an occurrence of a specified, programmed, or predetermined event. Such an event may include but is not limited to a save event, a restore event, a change to a device setting, a request from the host device (105-1), a request from the operator of the system (100), a request from the remote control device (120), an interruption of power to a component of the system (100), and an event related to the shutdown of the host device (105-1), the AV device (115), or the audiovisual system (100). For example, the host device (105-1) may request the setting status from the AV device (115) when the user initiates a save event by actuating a control associated with the save event. The control may be part of the remote control device (120) or the host device (105-1).

The functionalities of the system (100) are enhanced by the communications capabilities between the host device (105-1) and the AV device (115). The host device (105-1) can learn and save the status of the setting of the AV device (115). The host device (105-1) can then use the saved setting to control future configuration or operation of the AV device (115). For example, the host device (105-1) can transmit the saved setting to the AV device (115) and cause the AV device (115) to restore that particular saved setting. Through this functionality, the system (100) can memorize system settings and restore those system settings at a later time, thereby eliminating the need to individually reconfigure each component of the system (100). Each user of the system (100) may save personalized settings and subsequently restore those settings. In some embodiments, the user can save and restore settings by depressing a single control button.

The host device (105-1) can be configured to recognize a save event, which save event will indicate to the host device (105-1) to save the system settings. The save event can include instructions sent to the host device (105-1), commands generated by the user of the system (100), an actuation of a control associated with or communicatively coupled to the host device (105-1), an interruption of power to a component of the system (100), and a shutdown of the system (100) or a component of the system (100).

Similarly, the host device (105-1) can be configured to recognize a restore event. Upon recognition of the restore event, the host device (105-1) will restore specific saved settings to one or more linked AV devices (115). The restore event can include instructions sent to the host device (105-1), commands generated by a user of the system (100), an actuation of a control associated with or communicatively coupled to the host device (105-1), and a power up of the system (100) or a component of the system (100).

Assuming that the user of the system (100) wishes to save the system settings, the user may actuate the control that is associated with or communicatively coupled to the host device (105-1). The control may include buttons attached to the host device (105-1) or the remote control device (120). The host device (105-1) then recognizes the actuation of the control (105-1) as a save event and saves the settings of the linked AV devices (115) to a computer-readable medium. The host device (105-1) may have previously received the settings or it may poll the AV devices (115) by sending signals requesting the statuses of the settings. The AV devices (115) then respond by sending the settings to the host device (105-1), which settings are then received and saved by the host device (105-1). The host device (105-1) may follow this process to save the settings upon recognition of any save event.

Assuming now that the user of the system (100) wishes to restore previously saved system settings, the user may actuate the control that is associated with or communicatively coupled to the host device (105-1). The control may be dedicated to restore a particular number of settings that was associated with the control when the settings were saved. The host device (105-1) recognizes the actuation of the control as a restore event. The host device (105-1) then recalls the particular settings from memory and transmits the recalled settings to the appropriate AV devices (115). The host device (105-1) may follow this process to restore the settings to the AV devices (115) upon recognition of any restore event.

As mentioned above, the user may access the functionalities of the system (100) by using controls associated with the remote control device (120). As shown in FIG. 1, the remote control device (120) can interface with the host device (105-1) and/or the AV device (115) by wireless communications, including infrared (IR) communications or radio frequency (RF) communications. The user of the system (100) may use the remote control device (120) to control and configure the system (100).

The remote control device (120) includes controls configured to initiate communications to the host device (105-1) when actuated by the user. By actuating the controls, the user may control any setting or operation of the system (100). The controls may include buttons dedicated to a certain instruction or event.

In some embodiments, the user may initiate the save event for saving the setting by actuating a control button for a predetermined amount of time. The user may then initiate the restore event for restoring the saved setting by subsequently actuating the control button. Upon actuation of the control button, the remote control device (120) transmits the save or the restore instruction to the host device (105-1). The host device (105-1) can receive and then execute the instruction by sending and receiving commands over the connection medium (110).

The remote control device (120) may include a control dedicated to powering one or more of the system (100) components “on” or “off.” Similar to the save and restore controls, when the power control is actuated, the remote control device (120) communicates the power instruction to the host device (105-1), which host device (105-1) receives the power instruction and then transmits “off” or “on” instructions to the AV devices (115) over the connection medium (110).

Because the host device (105-1) is configured to communicate with the AV device (115), the remote control device (120) can control the AV device (115) by communicating solely with the host device (105-1). Accordingly, the remote control device (120) can be used to power the components of the system (100) “on” or “off” without communicating with each individual component, thereby eliminating complex and inconvenient setup tasks.

Assuming that the user of the system (100) wishes to save a particular system setting, such as a current channel of audiovisual programming, the user can actuate a control to initiate a save event associated with saving the channel setting. For example, the user may actuate a control dedicated to saving the currently selected channel of audiovisual programming. In some embodiments, the channel setting can be saved by pushing a dedicated button on the remote control device (120) for a predetermined amount of time. The system (100) can indicate that the setting has been saved, for example by emitting a sound that the user can hear. Once the button has been appropriately actuated, the host device (105) saves the current channel and configures the saved setting such that it can be restored when the same dedicated control is subsequently actuated.

Once the user has instructed the system (100) to save the channel setting, the user may change the selected channel to view another source of audiovisual programming. For example, the user may surf through any other channel or source of audiovisual programming available to the system (100). The surfing can include accessing linked AV devices (115) such as DVD players, video recorders, and gaming devices.

In some embodiments, the system (100) can be configured to send the saved channel's video signal to a picture-in-picture (PIP) window associated with the presentation device of the system. The user may surf other audiovisual programming in the primary window while checking the PIP window to know the status of the audiovisual programming on the saved channel. For example, when the program on the saved channel begins or resumes, the user may wish to restore the saved channel in order to return the saved channel's audiovisual programming to the primary window of the presentation device.

Assuming that the user wishes to restore the saved audiovisual programming channel, the user can easily cause the system (100) to recall and restore the channel. For example, the user may simply actuate the same control used to save the channel. In some embodiments, the user may push the dedicated button on the remote control device (120) to recall the channel setting that was saved and associated with the dedicated button.

By providing the ability to memorize and recall a particular system setting, the system (100) allows the user to freely surf through different audiovisual programming sources or channels during commercials or other breaks in a particular audiovisual program. Further, the user can surf through numerous channels without being limited to recalling only the immediately previous channel selection. Accordingly, the user can easily recall the saved channel from any point of system (100) operation, even at the touch of a button.

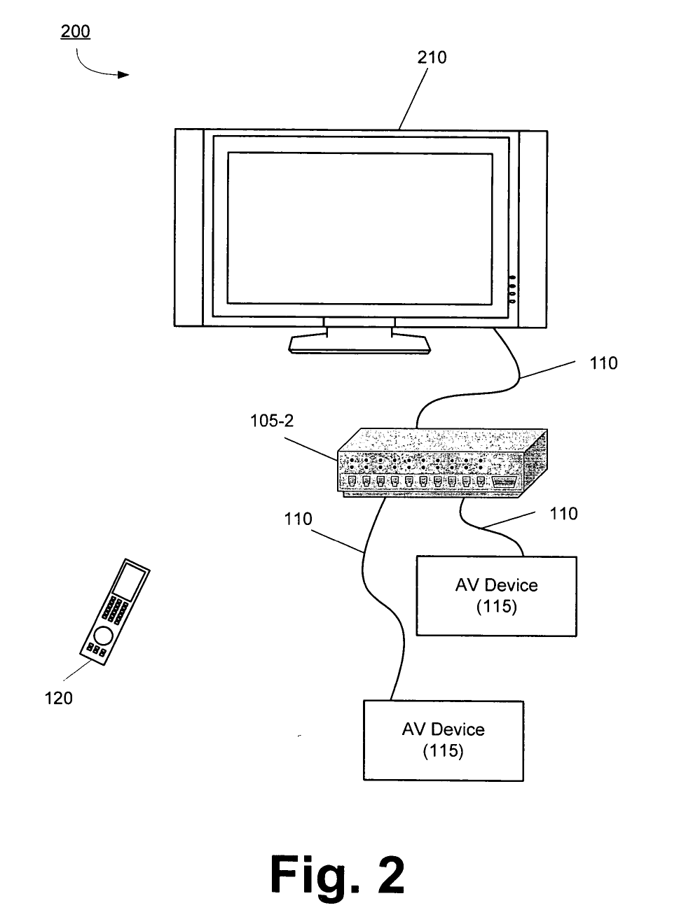

FIG. 2 illustrates another embodiment of an audiovisual system (200) according to the technology described herein. As shown in FIG. 2, the host device (105-2) is communicatively coupled by the connection medium (110) to multiple AV devices (115) and to a presentation device (210), such as a television set. As in FIG. 1, the remote control device (120) can be used to communicate with the host device (105-2) to control other system (200) components, including the presentation device (210). The host device (105-2) includes the functionalities of the host device (105-1, FIG. 1) discussed in FIG. 1. In the embodiment shown in FIG. 2, the host device (105-2) may be an audiovisual programming receiver, such as a set-top box. The host device (105-2) is able to control the presentation device (210) just as it can control the AV device (115). Further, the host-device (105-2) can send audiovisual programming to the presentation device (210) for presentation to the user.

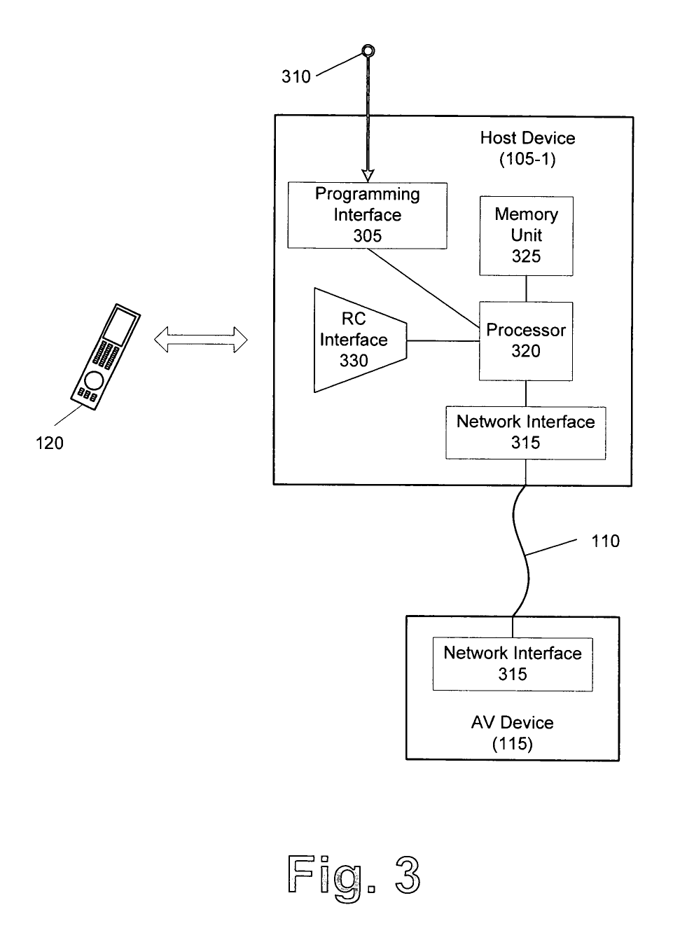

FIG. 3 illustrates elements of the devices associated with the system (100) in FIG. 1. As shown in FIG. 3, the host device (105-1) includes a programming interface (305) configured to interface with a programming source (310). The host device of FIG. 3 further includes a network interface (315) communicatively coupled to a processor (320), which processor (320) is communicatively coupled to a memory unit (325), a remote control (RC) interface (330), and the programming interface (305). The RC interface (330) is configured to communicate with the remote control device (120). The host device (105-1) is linked to the AV device (115) by the connection medium (110). The AV device (115) shown in FIG. 3 includes a network interface (315) for communicating via the connection medium (110). The AV device (115) may also include any other hardware or software helpful to communicating with the host device (105-1).

The programming interface (305) can include any electronic circuitry, programming, and functionality helpful for receiving and processing audiovisual programming from the programming source (310), including a tuner. The programming source (310) may include a head-end unit, a terrestrial receiver such as an antenna, and the AV device (115). When the programming interface (305) receives audiovisual programming, it can act upon or present the audiovisual programming in myriad ways, including facilitating transmittal of the audiovisual programming to one or more AV devices (115) via the connection medium (110).

The network interface (315) can include any electronic circuitry, programming, and functionality helpful for sending and receiving communications via the connection medium (110). The network interface (315) may include an IEEE 1394 interface or port capable of facilitating communications of digital signals over an IEEE 1394 pathway.

The RC interface (330) can include any electronic circuitry, programming, and functionality helpful for receiving and processing signals from the remote control device (120). The RC interface (330) performs any function helpful to preparing signals from the remote control device (120) for transmittal to the processor (320).

The processor (320) is capable of accessing and acting on signals communicated between the host device (105-1) and the AV device (115), including obtaining, saving, recalling, and causing transmittal of the settings of the AV devices (115) of the system (100). The processor (320) can also process signals received from the controls associated with associated with the host device (105-1) as well as signals received from the controls associated with remote control device (120) through the RC interface (330). The processor can recognize any of the events discussed above and then function accordingly to control the AV device (115).

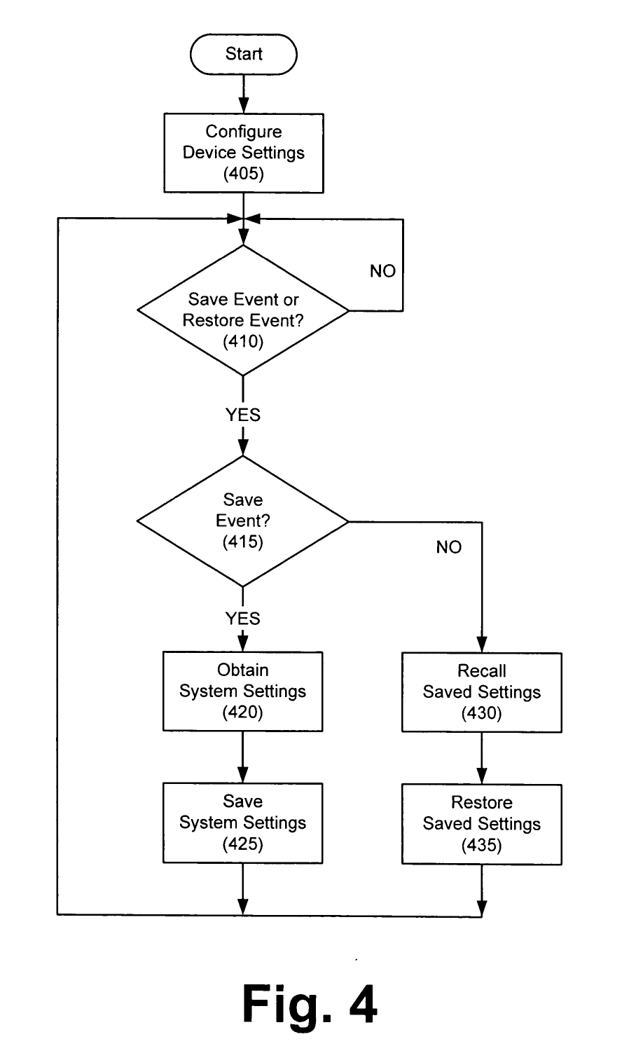

The processor (320) and any number of the interfaces (305, 315, and 330) shown in FIG. 3 may perform functions embodied as a set of processor-readable instructions stored on a processor-readable medium, such as the memory unit (325) of the host device (105-1), a hard drive, or computer disk. The flowchart of FIG. 4, discussed below, provides a functional description that allows such processor-readable instructions or code to be readily prepared in any of a variety of device programming languages.

The memory unit (325) can be any processor-readable medium. In some embodiments, the memory unit (325) includes non-volatile memory that allows stored data to be retained during a “power off” state of the host device (105-1). The memory unit (325) is capable of maintaining the system settings for processing by the processor (320).

FIG. 4 is a flowchart illustrating one method for operating the system (100) of FIG. 1. As shown in FIG. 4, the settings of a device (e.g., 115, FIG. 1) are configured (405). The settings of the device can be configured directly by the user, or the user can configure the device settings (405) through the host device (105, FIG. 1). The settings can also be configured (405) automatically when the device is connected to the audiovisual system (100, FIG. 1). The configuring of the device settings can include the configuration of default settings.

Next, it is determined if the save event or the restore event has occurred (determination 410). The save event and the restore event include anything discussed above in relation to FIG. 1. This determination (410) can involve waiting for and recognizing the occurrence of any save event or restore event. As shown in FIG. 4, if no save event or restore event is recognized, the method remains at the determination (410).

Once the save event or the restore event is recognized, it is determined whether that event is the save event (determination 415). If it is the save event, system settings are obtained (420). If the event is not the save event, then saved settings are recalled (430).

In the case where the event is the save event, system settings are obtained (420). This can involve polling the status of the AV device (115, FIG. 1) settings. Upon receiving a request for the status of the settings, the AV device (115, FIG. 1) communicates the settings to the host device (105-1). In this way, the system settings are obtained (420). The system settings may also be obtained (420) from the host device (105, FIG. 1) where the host device (105, FIG. 1) has previously received the settings from the AV device (115, FIG. 1).

Next, the system settings are saved (425). The settings can be stored to any computer-readable medium such that they can subsequently be identified and recalled. Once the settings have been saved (425), the method continues by again determining whether a save event or a restore event has occurred (410).

In the case where the determination (415) indicates that the event is the restore event, saved settings are recalled (430). This step involves identifying and accessing a particular group of settings represented on the computer-readable medium.

Next, the saved settings are restored (435). This step involves communicating the saved settings to the appropriate AV device (115, FIG. 1) such that the AV device (115, FIG. 1) is able to configure its settings accordingly.

The methods and systems for saving settings of audiovisual systems described herein provide for convenient and user-friendly ways to control components of audiovisual systems. The user can globally control the system settings. The settings can be configured manually or automatically such that the system can memorize system-wide device settings and cause saved settings to be restored to the appropriate components of the system. The user may save preferred system settings and subsequently restore those saved settings to the system components, even at the touch of a button.

The preceding description has been presented only to illustrate and describe embodiments of the invention. It is not intended to be exhaustive or to limit the invention to any precise form disclosed. Many modifications and variations are possible in light of the above teaching. It is intended that the scope of the invention be defined by the following claims.

1. A system for saving settings of an audiovisual system, comprising:
a first audiovisual device comprising a setting; and
a second audiovisual device communicatively coupled to said first audiovisual device;
wherein said second audiovisual device is configured to save said setting of said first audiovisual device upon a save event.

2. The system of claim 1, further comprising a remote control device configured to communicate said save event to said second audiovisual device.

3. The system of claim 2, wherein said save event includes an actuation of a control on said remote control device.

4. The system of claim 3, wherein said actuation includes actuating a button for a predetermined amount of time.

5. The system of claim 4, wherein a selected channel of audiovisual programming is saved upon said actuation.

6. The system of claim 1, wherein said save event includes a shutdown of at least one of said first audiovisual device and said second audiovisual device.

7. The system of claim 6, wherein said second audiovisual device automatically saves said setting upon said shutdown.

8. The system of claim 1, wherein said second audiovisual device is configured to restore said setting of said first audiovisual device upon a restore event.

9. The system of claim 8, further comprising a remote control device configured to communicate said restore event to said second audiovisual device.

10. The system of claim 9, wherein said restore event includes an actuation of a control on same said remote control device.

11. The system of claim 10, wherein a saved channel of audiovisual programming is restored upon said actuation.

12. The system of claim 8, wherein said restore event includes a power-up of at least one of said first audiovisual device and said second audiovisual device.

13. The system of claim 1, wherein said second audiovisual device is a television set.

14. The system of claim 1, wherein said second audiovisual device is a set-top box.

15. The system of claim 1, wherein said first audiovisual device is one of a digital video recorder and a digital video player.

16. The system of claim 1, wherein said first audiovisual device and said second audiovisual device are communicatively coupled by an IEEE 1394 pathway.

17. The system of claim 1, wherein said setting includes a selected input channel associated with said first audiovisual device.

18. An audiovisual host device, comprising:
an interface for communicatively coupling to an audiovisual device, wherein said audiovisual device includes a setting;
a computer-readable medium; and
a processor communicatively coupled to said interface and said computer-readable medium;
wherein said processor is configured to:
receive said setting from said interface upon a save event;
store said setting to said computer-readable medium upon said save event;
recall said setting from said computer-readable medium upon a restore event; and
communicate said recalled setting to said interface upon said restore event, wherein said recalled setting is configured to be restored to said audiovisual device.

19. The audiovisual host device of claim 18, wherein said audiovisual host device is a television set.

20. The audiovisual host device of claim 18, wherein said audiovisual host device is a set-top box.

21. The audiovisual host device of claim 18, wherein said save event includes an actuation of a control on a remote control device.

22. The audiovisual host device of claim 21, wherein said actuation includes actuating a button for a predetermined amount of time.

23. The audiovisual host device of claims 22, wherein a selected channel of audiovisual programming is saved upon said actuation.

24. The audiovisual host device of claim 18, wherein said restore event includes an actuation of a control associated with a remote control device.

25. The audiovisual host device of claims 24, wherein a saved channel of audiovisual programming is restored upon said actuation.

26. The audiovisual host device of claim 18, further comprising a remote control (RC) interface communicatively coupled to said processor, wherein said RC interface is configured to receive a signal representative of said save event or said restore event from a remote control device.

27. The audiovisual host device of claim 18, wherein said save event includes a shutdown of at least one of said first audiovisual device and said second audiovisual device.

28. The audiovisual host device of claim 27, wherein said processor automatically saves said setting upon said shutdown.

29. The audiovisual host device of claim 18, wherein said restore event includes a power-up of at least one of said first audiovisual device and said second audiovisual device.

30. The audiovisual host device of claim 18, further comprising a control communicatively coupled to said processor, wherein at least one of said save event and said restore event includes an actuation of said control.

31. The audiovisual host device of claim 18, further comprising a programming interface configured to receive an audiovisual programming signal from a source.

32. A method for retaining settings of an audiovisual system, comprising:
obtaining a setting from a first audiovisual device, wherein said first audiovisual device is communicatively coupled to a second audiovisual device; and
storing said setting to said second audiovisual device upon a save event.

33. The method of claim 32, wherein said save event includes an actuation of a control on a remote control device.

34. The method of claim 33, wherein said actuation includes actuating a button for a predetermined amount of time.

35. The method of claim 34, wherein a selected channel of audiovisual programming is saved upon said actuation.

36. The method of claim 32, further comprising receiving a signal representative of said save event from a remote control device, wherein said remote control device is configured to communicate said save event to said second audiovisual device.

37. The method of claim 32, wherein said save event includes a shutdown of at least one of said first audiovisual device and said second audiovisual device.

38. The method of claim 37, wherein said second audiovisual device automatically saves said setting upon said shutdown.

39. The method of claim 32, further comprising:
recalling said setting from said second audiovisual device upon a restore event; and
restoring said recalled setting to said first audiovisual device upon said restore event.

40. The method of claim 39, wherein said restore event includes an actuation of a control on said remote control device.

41. The method of claim 40, wherein a saved channel of audiovisual programming is restored upon said actuation.

42. The method of claim 39, further comprising receiving a signal representative of said restore event from a remote control device, wherein said remote control device is configured to communicate said restore event to said second audiovisual device.

43. The method of claim 39, wherein said restore event includes a power-up of at least one of said first audiovisual device and said second audiovisual device.

44. The method of claim 32, wherein said second audiovisual device is a television set.

45. The method of claim 32, wherein said second audiovisual device is a set-top box.

46. The method of claim 32, wherein said first audiovisual device is one of a digital video recorder and a digital video player.

47. The method of claim 32, wherein said first audiovisual device is communicatively coupled to said second audiovisual device by an IEEE 1394 pathway.

48. Processor-readable instructions stored on a processor-readable medium, such that said instructions, when executed, cause a processor to:
obtain a setting from a first audiovisual device, wherein said first audiovisual device is communicatively coupled to a second audiovisual device; and
store said setting to said second audiovisual device upon a save event.

49. The processor-readable instructions of claim 48, wherein said save event includes an actuation of a control on said remote control device.

50. The processor-readable instructions of claim 49, wherein said actuation includes actuating a button for a predetermined amount of time.

51. The processor-readable instructions of claim 50, wherein a selected channel of audiovisual programming is saved upon said actuation.

52. The processor-readable instructions of claim 48, further comprising receiving a signal representative of said save event from a remote control device, wherein said remote control device is configured to communicate said signal to said second audiovisual device.

53. The processor-readable instructions of claim 48, wherein said save event includes a shutdown of at least one of said first audiovisual device and said second audiovisual device.

54. The processor-readable instructions of claim 53, wherein said second audiovisual device automatically saves said setting upon said shutdown.

55. The processor-readable instructions of claim 48, wherein said processor-readable instructions further cause said processor to:
recall said setting from said second audiovisual device upon a restore event; and
restore said recalled setting to said first audiovisual device upon said restore event.

56. The processor-readable instructions of claim 55, wherein said restore event includes an actuation of a control on a remote control device.

57. The processor-readable instructions of claim 56, wherein a saved channel of audiovisual programming is restored upon said actuation.

58. The processor-readable instructions of claim 55, further comprising receiving a signal representative of said restore event from a remote control device, wherein said remote control device is configured to communicate said signal to said second audiovisual device.

59. The processor-readable instructions of claim 55, wherein said restore event includes a power-up of at least one of said first audiovisual device and said second audiovisual device.

60. A system for controlling the settings of an audiovisual system, comprising:
means for communicatively coupling a first audiovisual device to a second audiovisual device;
means for obtaining a setting from said first audiovisual device; and
means for storing said setting to said second audiovisual device upon a save event.

61. The system of claim 60, further comprising means for initiating said save event.

62. The system of claim 60, further comprising:
means for recalling said setting from said second audiovisual device upon a restore event; and
means for restoring said recalled setting to said first audiovisual device upon said restore event.

63. The system of claim 62, further comprising means for initiating said restore event.

64. A system for recalling settings of a network of audiovisual devices, comprising:
a network of interconnected audiovisual devices including a host device and a plurality of audiovisual devices, wherein said plurality of audiovisual devices includes a plurality of settings;
a connection medium configured to carry a communication associated with said plurality of settings between said plurality of audiovisual devices and said host device; and
a remote control device configured to communicate a save event and a restore event to said host device;
wherein said host device is configured to save said plurality of settings upon said save event and to restore said plurality of settings upon said restore event.
